(19) United States
(12) Patent Application Publication
(10) Pub. No.: US 2013/0082210 A1
(43) Pub. Date: Apr. 4, 2013

(54) Syngas Production Using Scrap Tire Gasification

(71) Applicants: Vivek GAUTAM, Bear, DE (US); Magnus Mortberg, Frankfurt (DE)

(72) Inventors: Vivek GAUTAM, Bear, DE (US); Magnus Mortberg, Frankfurt (DE)

(21) Appl. No.: 13/250,178

(22) Filed: Sep. 30, 2011

(51) Int. Cl. C01B 3/36

(52) U.S. Cl. 252/373

(57) ABSTRACT

A first carbon containing substance, which may be scrap tires, is introduced to pyrolitic reactor. The pyrolitic reactor produces at least a tar/char stream and a pyrolysis oil stream. Pyrolysis oil stream may also be combined with hydrogen stream and hydrotreated to produce synthetic diesel, synthetic jet fuel, or synthetic gasoline. At least a portion of hydrogen/carbon monoxide stream may be separated to provide hydrogen stream. An oxidant containing first gas may be oxygen or an oxygen rich stream. Gasification reactor may be a fluidized bed reactor, moving bed reactor, double fired reactor, entrained bed reactor or molten bath reactor. Pyrolitic reactor and gasification reactor may be thermally linked, with the exothermic pyrolitic reactor providing at least a portion of the heat required by endothermic gasification reactor.

### BACKGROUND

In 2007, the amount of waste tires generated was about 4.6 million tonnes in US, 3.4 million tonnes in Europe, close to 1 million tonnes in Japan, and around 1 million ton in China. In Europe, the main methods for waste tire management are materials recovery (38.7%), energy recovery (32.3%), and retreading (11.3%) whereas in the US, the main methods for waste tire management are tire derived fuel (52.8%), ground rubber (16.8%), and civil engineering applications (11.9%). Approximately 12% of all waste tires in US and Europe go to landfills and numbers can be much higher for China.

Gasification is a process that converts carbonaceous materials into carbon monoxide and hydrogen by reacting the raw material at high temperatures with a controlled amount of oxygen and/or steam. The resulting gas mixture is called synthesis gas or syngas and is itself a fuel. Gasification is a method for extracting energy from many different types of organic materials.

According to US Environment Protection Agency (EPA) the highest and best practical uses of scrap tires are recycle and waste to energy generation. Therefore, scrap tires are becoming very popular as fuel in certain industrial processes such as, cement kilns, pulp and paper, electric utilities, industrial boilers, lime kilns because of their high heating value (32 MJ/kg). They are used either in shredded form commonly known as tire derived fuel (TDF) or whole, depending on the type of industrial process. Typically scrap tires are added as a supplement to traditional fuels such as coal or wood. However there are still several challenges associated with burning tires in industrial systems such as toxic/carcinogenic emissions, impact on product quality, solid residue disposal and tire storage and handling.

Another way of extracting energy from waste tires is Pyrolysis to produce oil and carbon black. A lot of research has been/is being conducted on pyrolysis of discarded tires but commercial viability of such a technology is still suspect due to high energy requirement of the process. Since the oil produced by the pyrolysis process is similar to crude oil, the process is not profitable at present due to low crude oil prices. Moreover, the steel wires of tires and char by-products are challenging pyrolysis residues. The current start of the art is still not economically beneficial.

### SUMMARY

A first carbon containing substance is introduced to pyrolitic reactor. First carbon containing substance may be scrap tires. The pyrolitic reactor produces at least a tar/char stream and a pyrolysis oil stream. Pyrolysis oil stream may then be converted to a stream comprising hydrogen, carbon monoxide, and methane by any means known to the skilled artisan. Pyrolysis oil stream may also be combined with hydrogen stream and hydrotreated to produce synthetic diesel, synthetic jet fuel, or synthetic gasoline. Tar/char stream, along with second carbon containing substance and first gas stream are introduced into gasification reactor thereby producing at least steel/slag stream and hydrogen/carbon monoxide stream. At least a portion of hydrogen/carbon monoxide stream may be separated to provide hydrogen stream. Second carbon containing substance may contain coal or petroleum coke. Second carbon containing substance may contain visbreaker tar, pitch from deasphalting processes, vacuum residues or atmospheric residues. Second carbon containing substance may contain sugar cane, straw, hay, wood chips, bamboo and grasses. Second carbon containing substance may contain at least a portion of the scrap tires. First gas may be oxygen or an oxygen rich stream. Gasification reactor may be a fluidized bed reactor, moving bed reactor, double fired reactor, entrained bed reactor or molten bath reactor. Pyrolitic reactor and gasification reactor may be thermally linked, with the exothermic pyrolytic reactor providing at least a portion of the heat required by endothermic gasication reactor.

### BRIEF DESCRIPTION OF THE FIGURES

FIG. 1 illustrates a first arrangement between a pyrolytic reactor and a gasification reactor, in accordance with one embodiment of the present invention.

FIG. 2 illustrates a second arrangement between a pyrolytic reactor and a gasification reactor, in accordance with one embodiment of the present invention.

FIG. 3 illustrates a third arrangement between a pyrolytic reactor and a gasification reactor, in accordance with one embodiment of the present invention.

FIG. 4 illustrates a fourth arrangement between a pyrolytic reactor and a gasification reactor, in accordance with one embodiment of the present invention.

FIG. 5 illustrates a fifth arrangement between a pyrolytic reactor and a gasification reactor, in accordance with one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Compared to pyrolysis, gasification is an exothermic process so it is considered to be an attractive method for recovering energy and materials efficiently from scrap tires. It has been shown that the cost of H₂ produced from scrap tires is comparable to the cost of production from natural gas. It has also been shown that tire gasification produces high hydrogen content syngas compared to other solid wastes with gas yield in the range 30% of the tire mass. The yield of tar with tire gasification was also found to be very low for tire gasification compared to biomass and the ash can be further reprocessed to recover steel. More recently some studies have also suggested for a combined pyrolysis-gasification process using a two step fixed bed reactor for better product quality and yield.

A techno-economic model developed by University of California, Riverside indicates that gasification/pyrolysis of tires could be economically viable based on current market rates for commodities such as diesel fuel, off-peak electricity, and process heat. This includes generation of a positive cash flow after only a few years of operation and an overall cumulative cash flow over an 11-year period. This situation would likely improve in the future if commodity prices continue to rise. Another study predicted that for a waste with heating value above 25 MJ/kg and tipping fee close to $100/ton, the cost of hydrogen production will be close to $6/GJ which is equivalent to the cost of H₂ production from natural gas.

Gasification of tires could be done in a Lurgi type fixed bed gasifier with the tires as an addition to coal or another feed stock, or within a new development where the gasifier has to be operated in a way where clogging is avoided by addition of chemicals or mechanical stirring. Since a feedstock made out of tires will have physical properties that are different from conventional feedstock or biomass, new solutions will have to be found in order to ensure stable and secure operation. Lurgi has an extensive knowledge in gasification but specific developments concerning tire gasification technology has never been made. There are several strong benefits of hydrogen production from tire gasification. Some of them are following.
High energy content.
The ash has low heavy metals content.
Easy availability of raw material (scrap tires) in developed countries and increased supply forecasted in developing countries.
Increased focus of developed countries due to environment friendly process.

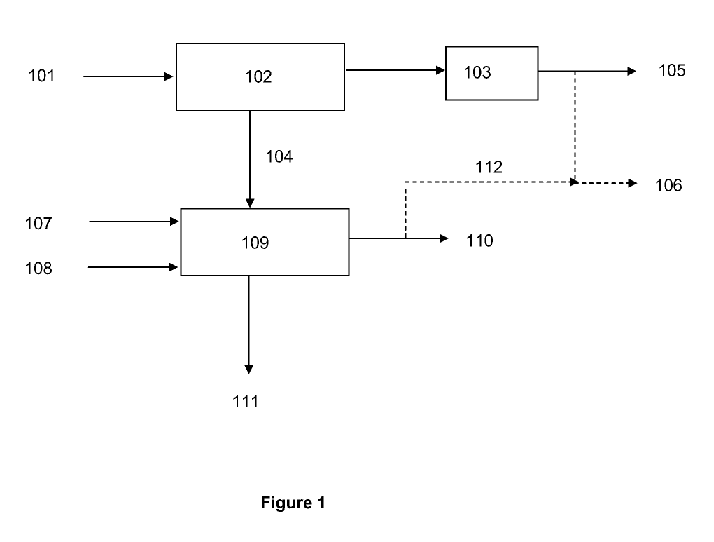

In the interest of consistency and clarity, the same element numbers are maintained throughout the figures. Turning to FIG. 1, a first carbon containing substance 101 is introduced to pyrolitic reactor 102. First carbon containing substance 101 may be scrap tires. The pyrolitic reactor 102 produces at least a tar/char stream 104 and a pyrolysis oil stream 103. Pyrolysis oil stream 103 may then be converted to a stream comprising hydrogen, carbon monoxide, and methane 105 by any means known to the skilled artisan. Pyrolysis oil stream 103 may also be combined with hydrogen stream 112 and hydrotreated to produce synthetic diesel, synthetic jet fuel, or synthetic gasoline 106. Tar/char stream 104, along with second carbon containing substance 107 and first gas stream 108 are introduced into gasification reactor 109 thereby producing at least steel/slag stream 111 and hydrogen/carbon monoxide stream 110. At least a portion of hydrogen/carbon monoxide stream 110 may be separated to provide hydrogen stream 112. Second carbon containing substance 107 may contain coal or petroleum coke. Second carbon containing substance 107 may contain visbreaker tar, pitch from deasphalting processes, vacuum residues or atmospheric residues. Second carbon containing substance 107 may contain sugar cane, straw, hay, wood chips, bamboo and grasses. First gas 108 may be oxygen or an oxygen rich stream. Gasification reactor 109 may be a fluidized bed reactor, moving bed reactor, double fired reactor, entrained bed reactor or molten bath reactor.

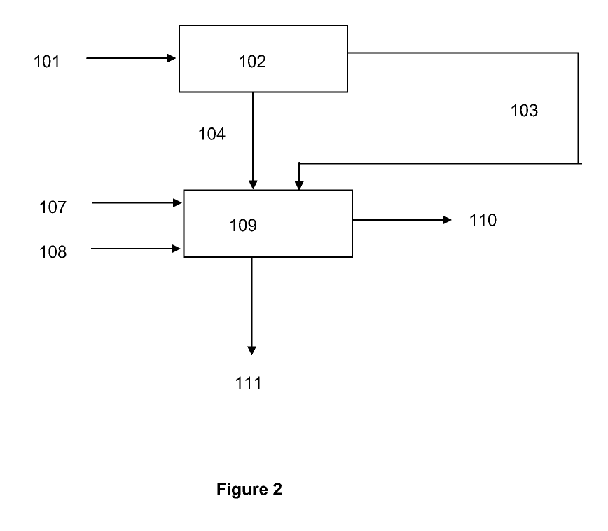

Turning to FIG. 2, a first carbon containing substance 101 is introduced to pyrolitic reactor 102. First carbon containing substance 101 may be scrap tires. The pyrolitic reactor 102 produces at least a tar/char stream 104 and a pyrolysis oil stream 103. Pyrolysis oil stream 103 along with tar/char stream 104, second carbon containing substance 107 and first gas stream 108 are introduced into gasification reactor 109 thereby producing at least steel/slag stream 111 and hydrogen/carbon monoxide stream 110. Second carbon containing substance 107 may contain coal or petroleum coke. Second carbon containing substance 107 may contain visbreaker tar, pitch from deasphalting processes, vacuum residues or atmospheric residues. Second carbon containing substance 107 may contain sugar cane, straw, hay, wood chips, bamboo and grasses. Second carbon containing substance 107 may contain at least a portion of the scrap tires. First gas 108 may be oxygen or an oxygen rich stream. Gasification reactor 109 may be a fluidized bed reactor, moving bed reactor, double fired reactor, entrained bed reactor or molten bath reactor.

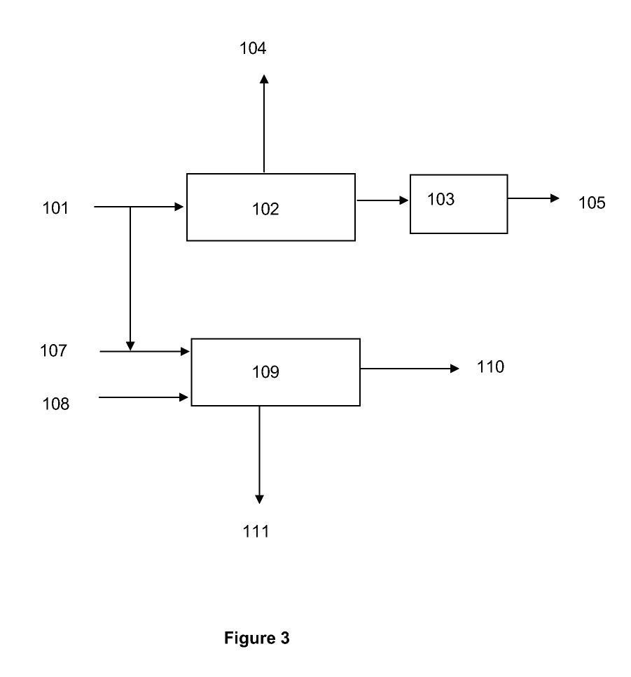

Turning to FIG. 3, a first carbon containing substance 101 is introduced to pyrolitic reactor 102. First carbon containing substance 101 may be scrap tires. The pyrolitic reactor 102 produces at least a tar/char stream 104 and a pyrolysis oil stream 103. Pyrolysis oil stream 103 may then be converted to a stream comprising hydrogen, carbon monoxide, and methane 105 by any means known to the skilled artisan. Pyrolysis oil stream 103 may also be combined with hydrogen stream 112 and hydrotreated to produce synthetic diesel, synthetic jet fuel, or synthetic gasoline 106. Tar/char stream 104, along with second carbon containing substance 107 and first gas stream 108 are introduced into gasification reactor 109 thereby producing at least steel/slag stream 111 and hydrogen/carbon monoxide stream 110. At least a portion of hydrogen/carbon monoxide stream 110 may be separated to provide hydrogen stream 112. Second carbon containing substance 107 may contain coal or petroleum coke. Second carbon containing substance 107 may contain visbreaker tar, pitch from deasphalting processes, vacuum residues or atmospheric residues. Second carbon containing substance 107 may contain sugar cane, straw, hay, wood chips, bamboo and grasses. Second carbon containing substance 107 may contain at least a portion of the scrap tires. First gas 108 may be oxygen or an oxygen rich stream. Gasification reactor 109 may be a fluidized bed reactor, moving bed reactor, double fired reactor, entrained bed reactor or molten bath reactor.

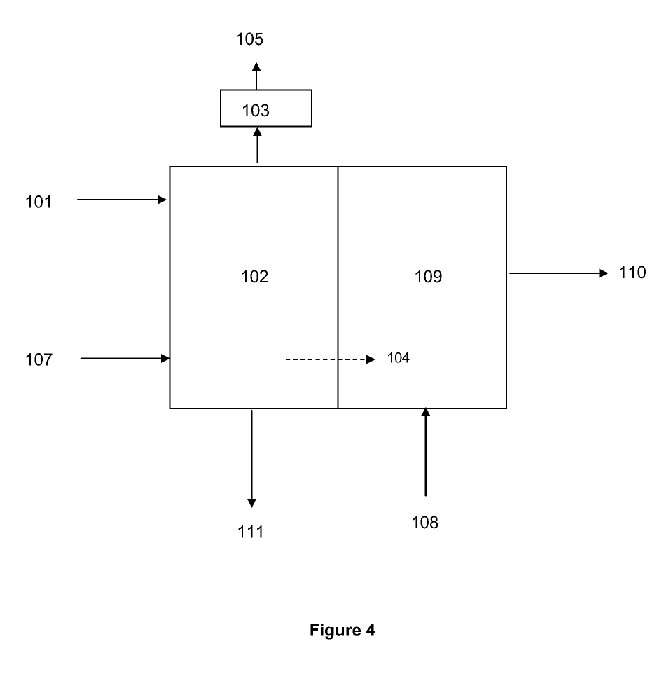

Turning to FIG. 4, a first carbon containing substance 101 and second carbon containing substance 107 are introduced to pyrolitic reactor 102. First carbon containing substance 101 may be scrap tires. Second carbon containing substance 107 may contain coal or petroleum coke. Second carbon containing substance 107 may contain visbreaker tar, pitch from deasphalting processes, vacuum residues or atmospheric residues. Second carbon containing substance 107 may contain sugar cane, straw, hay, wood chips, bamboo and grasses. The pyrolitic reactor 102 produces at least a tar/char stream 104, steel/slag stream 111, and a pyrolysis oil stream 103. Pyrolysis oil stream 103 may then be converted to a stream comprising hydrogen, carbon monoxide, and methane 105 by any means known to the skilled artisan. Pyrolysis oil stream 103 may also be combined with hydrogen stream 112 and hydrotreated to produce synthetic diesel, synthetic jet fuel, or synthetic gasoline. Tar/char stream 104 and first gas stream 108 are introduced into gasification reactor 109 thereby producing at least hydrogen/carbon monoxide stream 110. Pyrolitic reactor 102 and gasification reactor 109 are thermally linked, with the exothermic pyrolytic reactor 102 providing at least a portion of the heat required by endothermic gasication reactor 109. First gas 108 may be oxygen or an oxygen rich stream. Gasification reactor 109 may be a fluidized bed reactor, moving bed reactor, double fired reactor, entrained bed reactor or molten bath reactor.

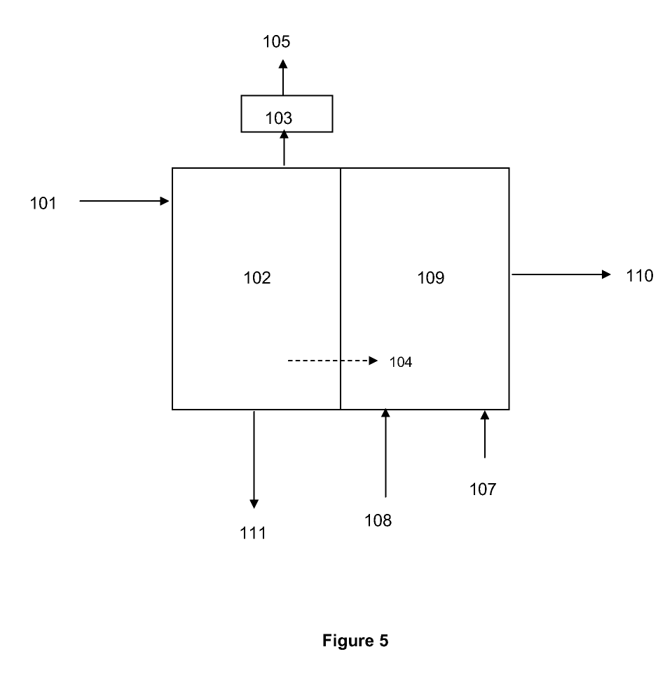

Turning to FIG. 5, a first carbon containing substance 101 is introduced to pyrolitic reactor 102. First carbon containing substance 101 may be scrap tires. The pyrolitic reactor 102 produces at least a tar/char stream 104, steel/slag stream 111, and a pyrolysis oil stream 103. Pyrolysis oil stream 103 may then be converted to a stream comprising hydrogen, carbon monoxide, and methane 105 by any means known to the skilled artisan. Pyrolysis oil stream 103 may also be combined with hydrogen stream 112 and hydrotreated to produce synthetic diesel, synthetic jet fuel, or synthetic gasoline. Tar/char stream 104, along with second carbon containing substance 107 and first gas stream 108 are introduced into gasification reactor 109 thereby producing at least hydrogen/carbon monoxide stream 110. At least a portion of hydrogen/carbon monoxide stream 110 may be separated to provide hydrogen stream 112. Second carbon containing substance 107 may contain coal or petroleum coke. Second carbon containing substance 107 may contain visbreaker tar, pitch from deasphalting processes, vacuum residues or atmospheric residues. Second carbon containing substance 107 may contain sugar cane, straw, hay, wood chips, bamboo and grasses. Second carbon containing substance 107 may contain at least a portion of the scrap tires. First gas 108 may be oxygen or an oxygen rich stream. Gasification reactor 109 may be a fluidized bed reactor, moving bed reactor, double fired reactor, entrained bed reactor or molten bath reactor. Pyrolitic reactor 102 and gasification reactor 109 are thermally linked, with the exothermic pyrolytic reactor 102 providing at least a portion of the heat required by endothermic gasication reactor 109.

It should be noted that while the invention has been described in several different embodiment, it is obvious that some additional embodiments can be developed or added by the persons skilled in the art or familiar with the technology to further improve the invention without departing from the scope of this disclosure. For example, a portion of the compressed air from the compressed air combined cycle loop can be injected into the gas turbine and heated by the combustion of air and fuel to form a hot gas then expanded in the gas turbine to generate power.

What is claimed is:

1. A method of gasification comprising;
Introducing a first carbon containing substance into a pyrolytic reactor, thereby producing at least pyrolysis oil, steel slag, tar and char;
introducing said tar and char, a first gas, and a second carbon containing substance into a gasification reactor, thereby producing at least a first hydrogen and carbon monoxide stream; and
refining said pyrolysis oil to produce a second hydrogen and carbon monoxide stream.

2. The method of claim 1, wherein said first carbon containing substance comprises scrap tires.

3. The method of claim 2, wherein said first carbon containing substance further comprises at least a portion of said second carbon containing substance.

4. The method of claim 1, wherein said second carbon containing substance is selected from the group consisting of coal or petroleum coke.

5. The method of claim 1, wherein said second carbon containing substance is selected from the group consisting of visbreaker tar, pitch from deasphalting processes, vacuum residues, and atmospheric residues.

6. The method of claim 1, wherein said second carbon containing substance is selected from the group consisting of sugar cane, straw, hay, wood chips, bamboo, and grasses.

7. The method of claim 1, wherein said second carbon containing substance is at least a portion of said scrap tires.

8. The method of claim 1, wherein said first gas is selected from the group consisting of steam, oxygen and air.

9. The method of claim 1, wherein said first gas is oxygen.

10. The method of claim 1, wherein said pyrolitic reactor and said gasification reactor are thermally linked, with said pyrolitic reactor providing at least a portion of the heat required by said gasification reactor.

11. The method of claim 1, wherein said gasification reactor is selected from the group consisting of fluidized bed, moving bed, double fired, entrained bed, and molten bath.

12. A method of gasification comprising;
Introducing a first carbon containing substance into a pyrolytic reactor, thereby producing at least pyrolysis oil, steel slag, tar and char; and
introducing said pyrolysis oil, tar and char, and a first gas, into a gasification reactor, thereby producing at least a hydrogen and carbon monoxide stream.

13. The method of claim 12, wherein said first carbon containing substance comprises scrap tires.

14. The method of claim 13, wherein said first carbon containing substance further comprises at least a portion of a second carbon containing substance.

15. The method of claim 12, further comprising introducing a second carbon containing substance into said gasification reactor.

16. The method of claim 14, wherein said second carbon containing substance is selected from the group consisting of coal or petroleum coke.

17. The method of claim 15, wherein said second carbon containing substance is selected from the group consisting of coal or petroleum coke.

18. The method of claim 14, wherein said second carbon containing substance is selected from the group consisting of visbreaker tar, pitch from deasphalting processes, vacuum residues, and atmospheric residues.

19. The method of claim 15, wherein said second carbon containing substance is selected from the group consisting of visbreaker tar, pitch from deasphalting processes, vacuum residues, and atmospheric residues

20. The method of claim 14, wherein said second carbon containing substance is selected from the group consisting of sugar cane, straw, hay, wood chips, bamboo, and grasses.

21. The method of claim 15, wherein said second carbon containing substance is selected from the group consisting of sugar cane, straw, hay, wood chips, bamboo, and grasses

22. The method of claim 14, wherein said second carbon containing substance is at least a portion of said scrap tires.

23. The method of claim 15, wherein said second carbon containing substance is at least a portion of said scrap tires.

24. The method of claim 12, wherein said first gas is selected from the group consisting of steam, oxygen and air.

25. The method of claim 12, wherein said first gas is oxygen.

26. The method of claim 12, wherein said pyrolitic reactor and said gasification reactor are thermally linked, with said pyrolitic reactor providing at least a portion of the heat required by said gasification reactor.

27. The method of claim 12, wherein said gasification reactor is selected from the group consisting of fluidized bed, moving bed, double fired, entrained bed, and molten bath.
